(19) United States
(12) Patent Application Publication
(10) Pub. No.: US 2006/0016478 A1
(43) Pub. Date: Jan. 26, 2006

(54) Bending sleeve clamp for controlling fluid flow in a flexible tube

(76) Inventor: Vinit Chantalat, Los Altos Hills, CA (US)

Correspondence Address: SILICON VALLEY PATENT GROUP LLP, 2350 MISSION COLLEGE BOULEVARD, SUITE 360, SANTA CLARA, CA, 95054, US

(21) Appl. No.: 10/897,057

(22) Filed: Jul. 21, 2004

(51) Int. Cl. F16K 7/04

(52) U.S. Cl. 137/223; 251/4

(57) ABSTRACT

A bending sleeve clamp is used to control the flow of a fluid (liquid or gas) in a flexible tube. The flexible tube extends through a pair of rigid sleeves that are connected by a bending sleeve. The rigid sleeves are manipulated to bend the bending sleeve so as to form a kink in the bending sleeve, which pinches and closes off the flow in the flexible tube. The bending sleeve clamp may be biased in either an open or closed position. Preferably, the bending sleeve is pre-kinked to define where the kink will be formed and to grip the flexible tube. In addition, the bending sleeve clamp may include a mechanism to prevent the bending sleeve from being bent too far or from being stretched too much.

### FIELD OF THE INVENTION

This invention relates to devices used to control the flow of a fluid through a flexible tube.

### BACKGROUND

There are many situations in which it is desired to control the flow of a fluid (liquid or gas) through a flexible tube. One of the most common is the ordinary garden hose. Other examples include air supply hoses, garden chemical sprayers, and the tubes used for the intravenous (IV) administration of medicines or nutrients to a patient.

Ordinarily a clamp or valve is used for this purpose. Many clamps and valves are relatively complicated, with a number of parts which must be machined very accurately and which must be carefully assembled. These requirements add to the expense of the valve. Often, at least some of the parts must be made of metal, which is relatively expensive as compared with plastic, for example.

In addition, with some valves it is difficult to control very low flow rates. There may be a surge of fluid when the valve is first opened, and the valve may abruptly shut off the flow of fluid as it is closed. Conversely, it is often difficult to get a full, unrestricted flow through the valve; the valve seat and other internal parts get in the way of the flow even when the valve is fully open.

U.S. Pat. No. 4,312,493 discloses a control valve for infusing an IV fluid. The valve contains a screw mechanism that pinches the tubing. Unfortunately, this type of mechanism is relatively expensive and cumbersome. Expense is a major factor to be considered, especially when the valve is to be purchased and used in less-developed countries.

U.S. Pat. No. 4,610,664 discloses an operation aspirator with control valve. The valve uses a gate that obstructs but does not fully close off the flow of a liquid. Moreover, the valve cannot withstand a pressure greater than 10-20 psi.

U.S. Pat. No. 4,689,043 discloses an IV tube activator which uses a sliding clamp to close off the passage of a liquid in a flexible tube. The clamp is usable with only one size of flexible tube, however, and it cannot be used to shut off flow at different locations along the length of the flexible tube. After usage, the flexible tube must be discarded.

U.S. Pat. No. 5,453,098 discloses a clamp that is similar to the clamp shown in U.S. Pat. No. 4,689,043, except that in U.S. Pat. No. 5,453,098 the clamp is in a stationary portion of the device.

U.S. Pat. Nos. 3,630,481, 3,685,787, 4,238,108 and 5,190,079 disclose various forms of rolling clamps. In order to close off the flow of liquid, one must rotate the roller several revolutions, and considerable force is required to close the flexible tube. Thus, it is difficult to close off the flow of liquid quickly. Also, these devices are generally usable only with pressures in the range of 10-20 psi.

Accordingly, there is a definite need for a clamp that is relatively inexpensive to manufacture, that can be made entirely of plastic materials, and that can be used to precisely control the release of a fluid. Furthermore, the clamp should be: (a) operable with a single hand, (b) slidable along the flexible tube, (c) usable with flexible tubes of various diameters, (d) capable of controlling highly pressurized fluids, and (e) require minimal force to shut off the flow of fluid.

### SUMMARY

The bending sleeve clamp of this invention comprises a bending sleeve, a pair of rigid sleeves and a locking mechanism. The rigid sleeves are connected by the bending sleeve. Each of the rigid sleeves defines an axis. The bending mechanism operates to move the sleeves between a closed position, in which the sleeves are oriented such that their respective axes form a relatively small angle, and an open position, in which the sleeves are oriented such that their respective axes form a relatively large angle. In one embodiment, for example, the relatively small angle is about 90 degrees and the relatively large angle is about 180 degrees.

A flexible tube is passed through the bending sleeve and the rigid sleeves. The outer diameter of the tube is smaller than the inner diameter of the sleeves. When the sleeves are in the closed position, a kink is formed in the bending sleeve. The kink pinches the flexible tube, preventing the passage of fluid through the tube. When the locking mechanism is released, the kink in the bending sleeve is relaxed, and fluid is allowed to flow through the flexible tube. As the sleeves continue to move in a direction from the closed position to the open position, the fluid flows through the tube at a progressively greater flow rate. As used herein, a “kink” is defined as a condition caused by the bending of the bending sleeve in which the internal surfaces of the bending sleeve pinch the flexible tube so as to close off the flow of a fluid in the flexible tube.

The locking mechanism may include a stop to prevent the bending sleeve from being bent beyond the closed position of the clamp.

The bending sleeve clamp of this invention has numerous advantages. It is simple, relatively inexpensive to manufacture, and contains no moving parts. Many embodiments are made entirely of plastic. It is typically a hand-held device, and many embodiments can be operated (opened and closed) with the fingers and thumb of one hand. The force required to operate the bending sleeve clamp is typically very small. The bending sleeve clamp can control the flow of a highly pressurized liquid or gas in the flexible tube. A single bending sleeve clamp can be used with flexible tubes having various outside and inside diameters and wall thicknesses; the only requirement is that the outside diameter of the flexible tube be less than the inside diameters of the rigid sleeves and the bending sleeve. The bending sleeve clamp and flexible tube may be purchased separately and from different sources. The flexible tube may slide within the bending sleeve, allowing the shut-off position on the flexible tube to be varied. The bending sleeve clamp can be used to control the flow of fluid in the flexible tube accurately. The shut-off and turn-on of the fluid is an abrupt action, but there is no “surge” of the kind that often occurs when a valve is first opened.

### BRIEF DESCRIPTION OF THE DRAWINGS

FIGS. 1A and 1B are detailed cross-sectional views of the flexible tube inside the bending sleeve when the bending sleeve clamp is in the open position.

FIG. 1C is a detailed cross-sectional view of the flexible tube inside the bending sleeve when the bending sleeve clamp is in the closed position.

FIGS. 2A and 2B are conceptual views of the bending sleeve clamp of this invention.

FIG. 3 is a detailed cross-sectional view of the bending sleeve.

FIGS. 4A-4D are a sequence of cross-sectional views showing progressively how the bending sleeve closes.

FIG. 5A shows a bending sleeve clamp that includes a buckle type of locking mechanism.

FIG. 5B is a detailed view of the locking prong in the bending sleeve clamp of FIG. 5A.

FIG. 6 is a cross-sectional view of the bending sleeve clamp of FIG. 5A in the closed position.

FIG. 7 shows the bending sleeve clamp of FIG. 5A in an open position.

FIG. 8 shows how the bending sleeve clamp of FIG. 5A may be gripped to close it.

FIG. 9 shows a bending sleeve clamp that includes a hook-to-hook locking mechanism.

FIG. 10 is a cross-sectional view of the bending sleeve clamp of FIG. 9 in the closed position.

FIG. 11 shows how a user may open the bending sleeve clamp of FIG. 9.

FIG. 12 shows how a user may close the bending sleeve clamp of FIG. 9.

FIG. 13 shows a bending sleeve clamp which utilizes an elastic band to maintain the clamp normally in the closed position.

FIG. 14 shows a cross-sectional view of the bending sleeve clamp of FIG. 13 in the closed position.

FIGS. 15 and 16 show the bending sleeve clamp of FIG. 13 in the open position.

FIG. 17 shows how a user may open the bending sleeve clamp of FIG. 13.

FIGS. 18A and 18B show a handle-type bending sleeve clamp.

FIG. 19 shows a sprayer system that includes the bending sleeve clamp of FIG. 19

FIG. 20 is a cross-sectional view of the nozzle in the sprayer system of FIG. 19.

FIG. 21 shows a tool that can be used to form a pre-kink in the bending sleeves.

FIG. 22 is a general view of an inflation system that includes a bending sleeve clamp of this invention.

FIG. 23A shows a cross-sectional view of the pressure bottle in the inflation system.

FIG. 23B shows the state of the pressure relief indentation in the pressure bottle when the maximum pressure has been exceeded.

FIGS. 24A and 24B are cross-sectional views of the air chuck in the closed and open positions, respectively.

FIG. 25 is a partial cross-sectional view of the valve stem cap on the pressure bottle.

FIG. 26 is a cross-sectional view of the anti-kink connector that connects the flexible tube and the air chuck.

FIGS. 27 and 28 illustrate the components of an arrangement for connecting two pressure bottles in the inflation system.

FIGS. 29 and 30 illustrate the components of an arrangement for connecting four pressure bottles in the inflation system.

### DETAILED DESCRIPTION

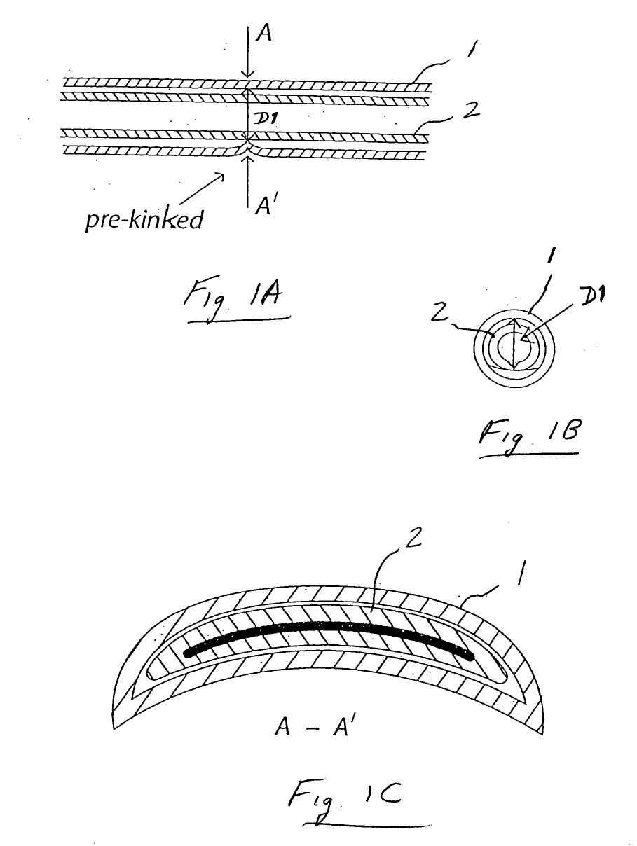

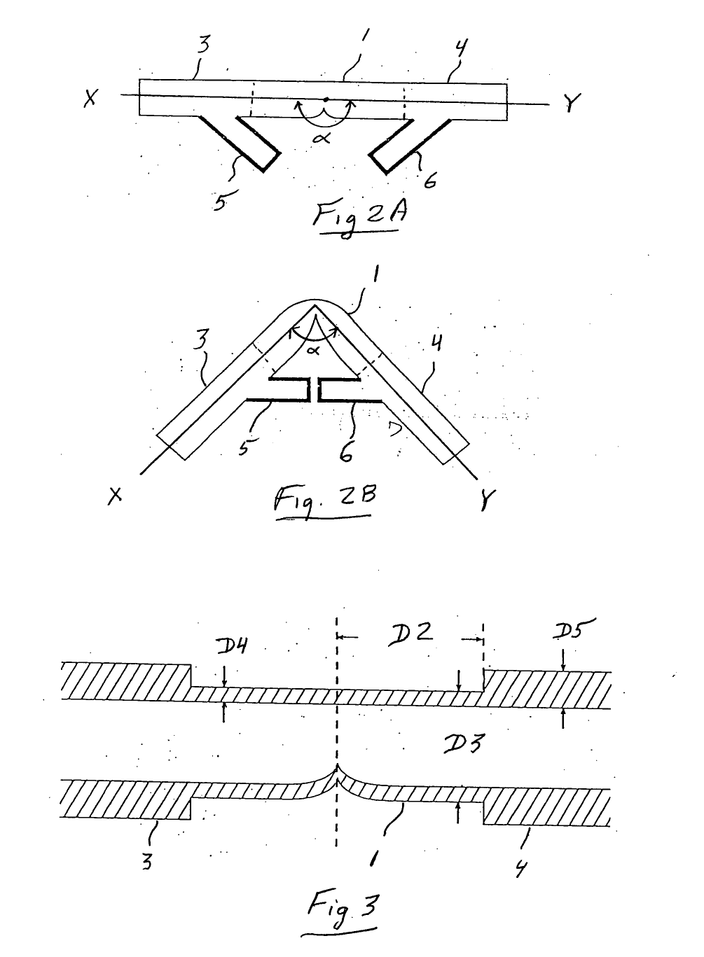

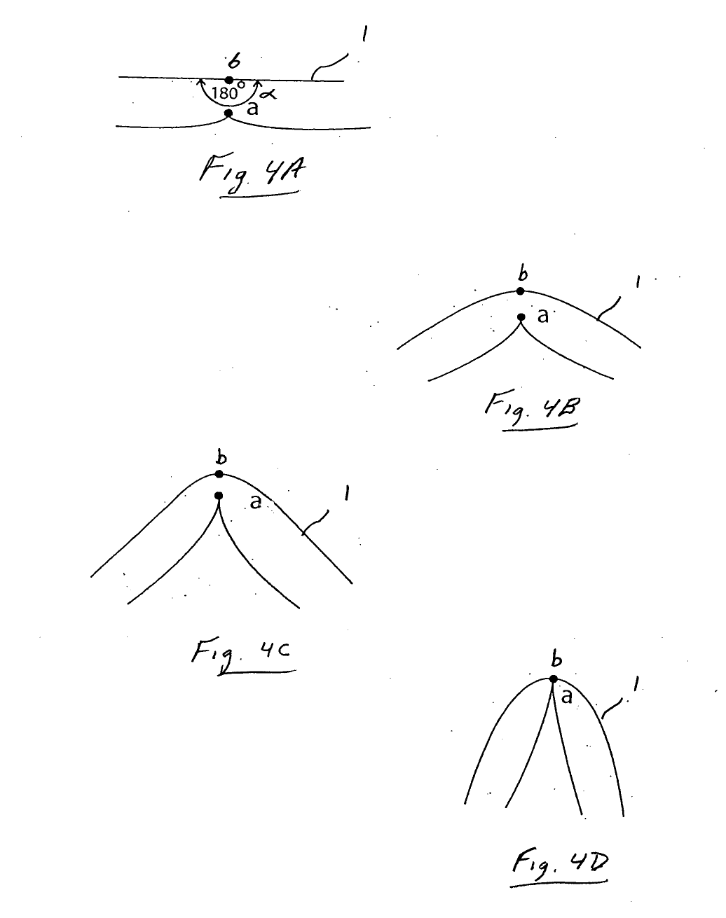

FIGS. 1-4 illustrate the general principles of this invention. FIG. 1A is a longitudinal cross-sectional view of a flexible tube 2 running through a bending sleeve 1. While both flexible tube 2 and bending sleeve 1 are flexible, bending sleeve 1 is fabricated of a harder material than tube 2. For example, bending sleeve 1 may be made of low-density polyethylene having a Shore hardness in the range of 90. Flexible tube 2 may be made of polyvinyl chloride or polyurethane having a Shore hardness in the range of 70-80.

As indicated, bending sleeve 1 is “pre-kinked” at the location of transverse cross-section A-A′, which is shown in FIG. 1B. The internal dimension D1 of bending sleeve 1 at cross-section A-A′ is slightly smaller than the normal inner diameter of bending sleeve 1 and approximately equal to the outer diameter of tube 2. The location of the “pre-kink” determines where bending sleeve 1 will kink when in operation. In some embodiments, the pre-kink also helps to grip the flexible tube and prevent it from sliding longitudinally inside the bending sleeve when the bending sleeve clamp is in its relaxed condition.

Bending sleeve 1 can be pre-kinked using the tool shown in FIG. 21. Before the assembly of the bending sleeve clamp, a group of bending sleeves 7 are arranged side-by-side in a fixture 8, which contains a trough 8A having a width approximately equal to the length of the bending sleeves 7. The fixture 8 is positioned in a punch tool, and a chisel-like die 9 is lowered against the bending sleeves 7, sufficient pressure being applied to deform the bending sleeves 7 without damaging them. The result is the formation of a pre-kink of the kind shown FIG. 1A in each of the bending sleeves 7.

FIG. 1C shows cross-section A-A′ when bending sleeve 1 is bent about 90 degrees. Note that a kink has formed in bending sleeve 1, which pinches flexible tube 2, preventing the flow of a fluid through tube 2. Bending sleeve 1 is tested to be able to withstand repeated bending with very little stress, and hence no breakage, at the position of the pre-kink.

FIGS. 2A and 2B are conceptual drawings of a bending sleeve clamp according to this invention. Bending sleeve 1 is connected between rigid sleeves 3 and 4. A stop 5 is attached to rigid sleeve 3 and a stop 6 is attached to rigid sleeve 4. Rigid sleeve 3 has an inner diameter that is approximately equal to the inner diameter of bending sleeve 1 and that defines an axis X. Rigid sleeve 4 also has an inner diameter that is approximately equal to the inner diameter of bending sleeve 1 and that defines an axis Y. With the clamp in the open position, as shown in FIG. 2A, axes X and Y form an angle α that is approximately equal to 180 degrees. With the clamp in the closed position, as shown in FIG. 2B. the angle α is approximately equal to 90 degrees. Note that stops 5 and 6 meet in the closed position to prevent the angle α becoming less than 90 degrees.

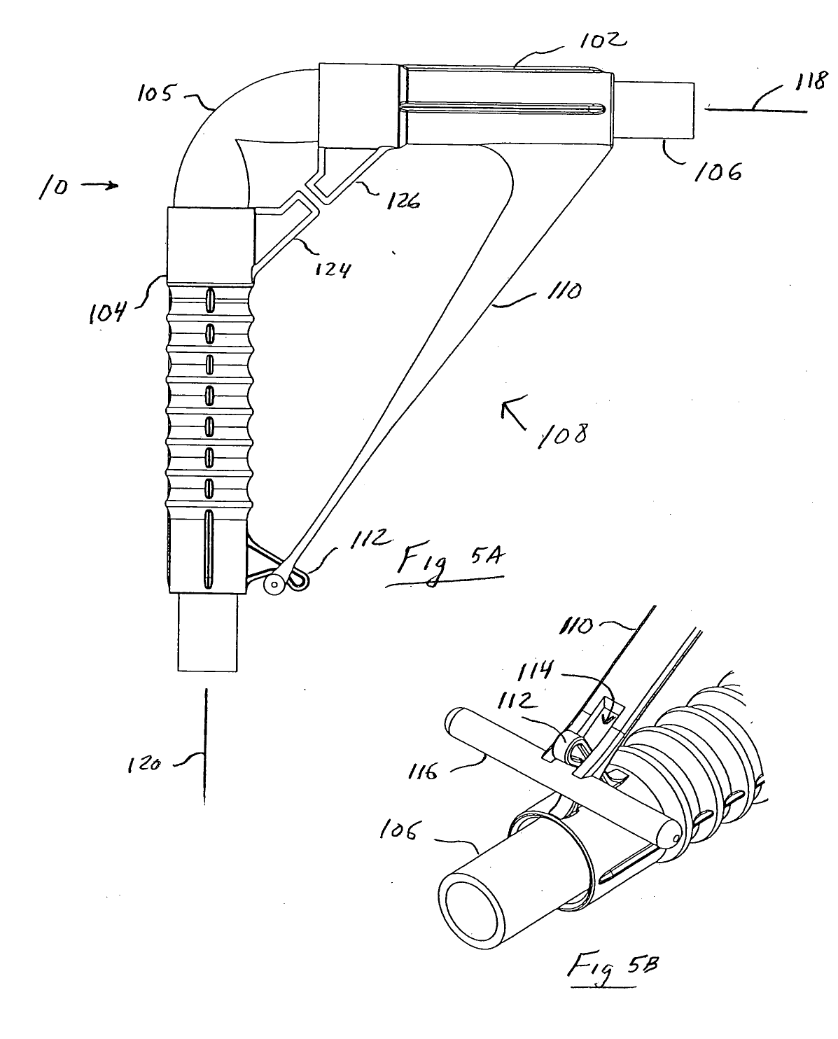

FIG. 3 is a detailed cross-sectional view of bending sleeve 1 and rigid sleeves 3 and 4. The distance D2 between each of the rigid sleeves 3 and 4, respectively, and the midpoint (pre-kink) of bending sleeve 1 is preferably greater than the outer diameter D3 of bending sleeve 1. The outer diameter D3 of bending sleeve 1 is typically in the range of 3 mm to 40 mm, and the thickness D4 of bending sleeve 1 is typically in the range of 0.5 mm to 3.0 mm. The thickness D5 of rigid sleeves 3 and 4 can be any value, and in fact rigid sleeves 3 and 4 do not have to be absolutely rigid but may be somewhat flexible provided that they are more rigid than bending sleeve 1.

The thickness D4 may be determined by a trial-and-error process to ensure that the tube 2 is completely pinched of when the clamp is in the closed position (typically when axes X and Y are at a 90 degree angle). FIGS. 4A-4D illustrate how the lower wall “a” approaches the upper wall “b” of bending sleeve 1 as the angle a becomes smaller. The objective is to have points “a” and “b” be spaced by a distance that closes off the flow of a fluid in the flexible tube 2 when the axes defined by the rigid sleeve are at the desired angle.

The basic components of the clamp of this invention are the bending sleeve, the rigid sleeves (which, as described above, do not have to be absolutely rigid) and the locking mechanism. The locking mechanism, which may include stops and other elements, may take various forms, as illustrated in FIGS. 5-18.

FIGS. 5A and 5B show a bending sleeve clamp 10 that includes a buckle type of locking mechanism. Bending sleeve clamp 10 includes a first rigid sleeve 102 and a second rigid sleeve 104, which are connected by a bending sleeve 105, and a locking mechanism 108. In FIG. 5A, a flexible tube 106 is fitted through bending sleeve 105 and rigid sleeves 102 and 104, the outside diameter of flexible tube 106 being slightly smaller than the inside diameter of bending sleeve 105 and rigid sleeves 102 and 104. Flexible tube 106 could have an outer diameter from 7/16″ to 1⅛″, for example, and could be a garden hose or a car wash hose, with the spray nozzle connected to the discharge end of the hose.

Bending sleeve clamp 10 is in the closed position in FIG. 5A. Locking mechanism 108 includes an arm 110, which extends from rigid sleeve 102, and a locking prong 112, which extends from rigid sleeve 104. As shown in the detailed view of FIG. 5B, locking prong 112 fits into a slot 114 at the end of arm 110 when bending sleeve clamp 10 is in the closed position. A transverse handle 116 assists the user in gripping arm 110 and fitting prong 112 into slot 114.

Referring still to FIG. 5A, rigid sleeve 102 defines a first axis 118, and rigid sleeve 104 defines a second axis 120. Axes 118 and 120 are oriented at an angle of about 90 degrees when bending sleeve clamp 10 is closed. Locking mechanism 108 also includes stops 124 and 126, which prevent the angle between axes 118 and 120 from becoming less than about 90 degrees. Referring to FIG. 6, which is a cross-sectional view of bending sleeve clamp 10 and flexible tube 106 in the closed position, it is apparent that a kink 122 is formed in bending sleeve 105, pinching and preventing the flow of fluid through flexible tube 106.

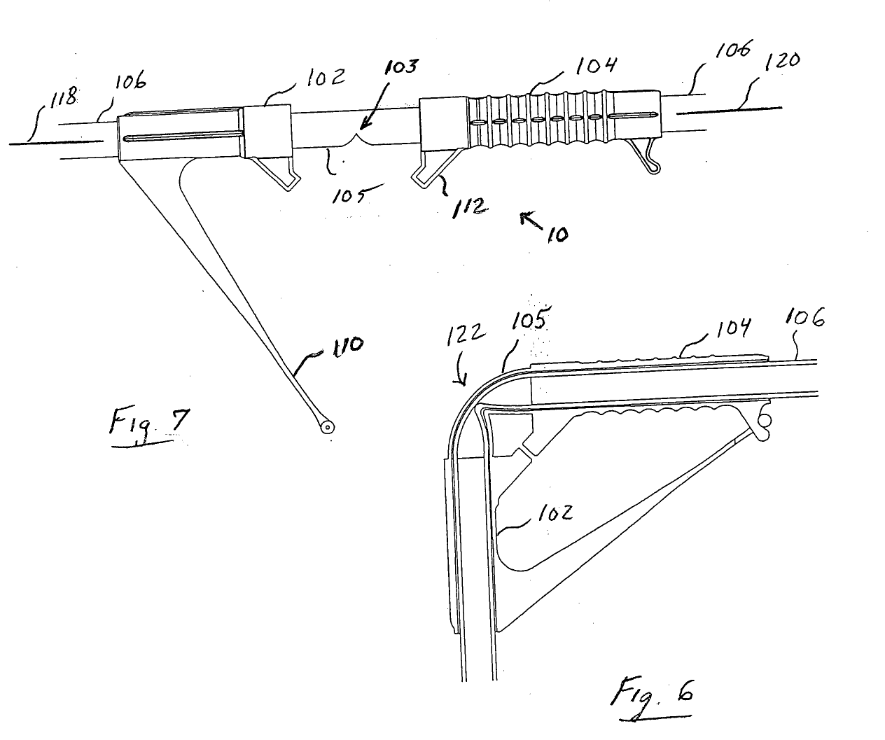

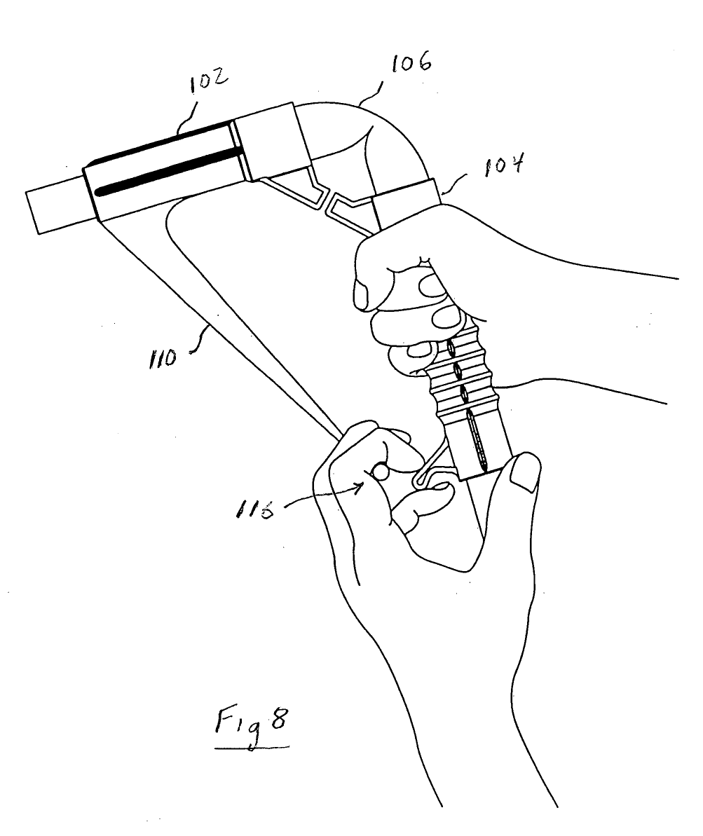

FIG. 7 illustrates bending sleeve clamp 10 in the open position, with arm 110 disengaged from prong 112. In this condition, the axes 118 and 120 form an angle approximately equal to 180 degrees, allowing a fluid to flow unrestricted through bending sleeve clamp 10. A pre-kink 103 in bending sleeve 105 is also shown.

FIG. 8 illustrates how handle 116 can be gripped by a user in order to close bending sleeve clamp 10.

Bending sleeve clamp 10 is preferably made entirely of plastic. As noted above, bending sleeve 105 is preferably made of low-density polyethylene. Rigid sleeves 102 and 104 and locking mechanism 108 can also be made of low-density polyethylene, although of a thickness that prevents these components from permanently flexing or bending. Rigid sleeves 102 and 104 and bending sleeve 105 are preferably manufactured by compression molding and in a single mold. In that case, rigid sleeves 102 and 104 and bending sleeve 105 are in reality portions of a single article of manufacture. Alternatively, rigid sleeves 102 and 104 and bending sleeve 105 could be manufactured in separate molds and bonded together or otherwise attached afterward.

Flexible tube 106 is preferably manufactured by protrusion molding and, as noted above, can be made of polyvinyl chloride or polyurethane.

The rigid sleeves, bending sleeve and flexible tube in other embodiments of this invention can be manufactured in a similar manner.

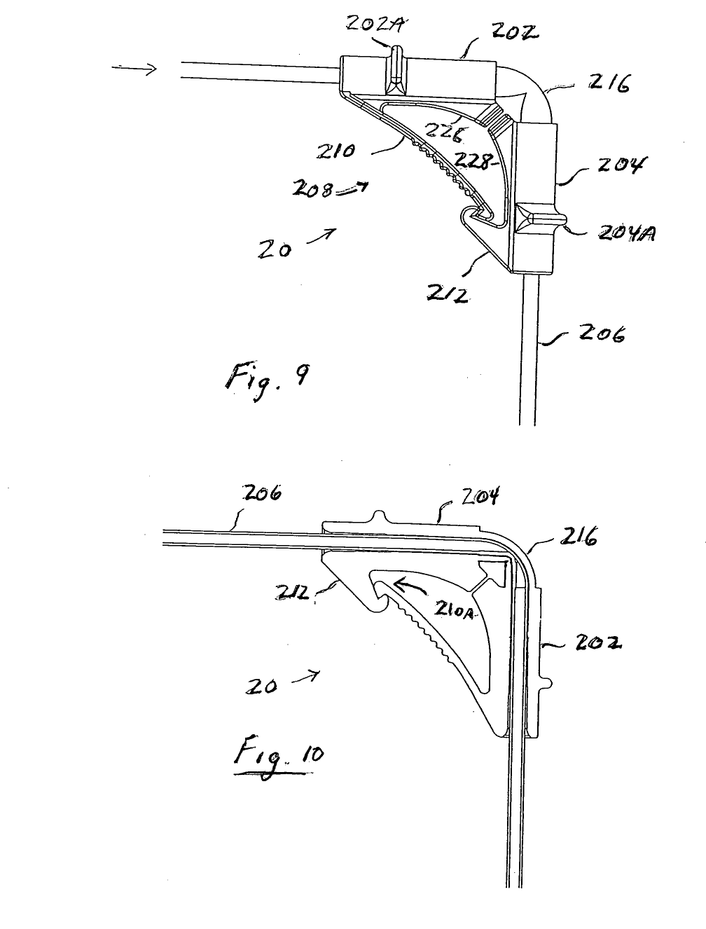

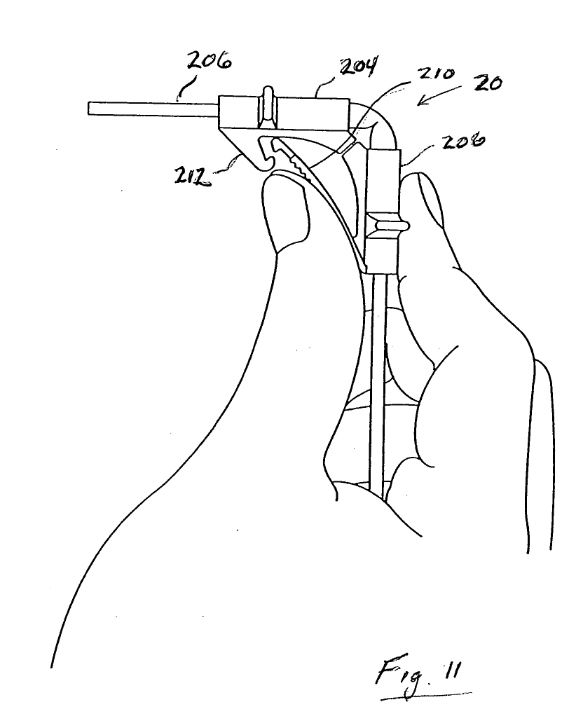

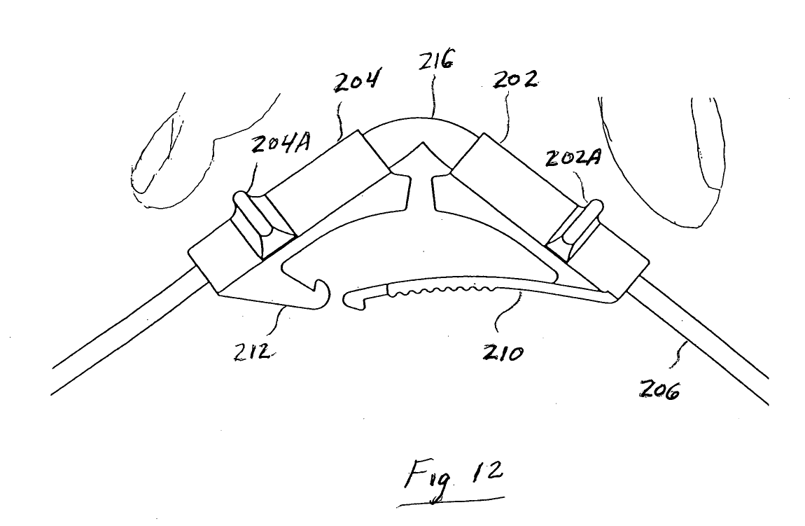

FIGS. 9-12 illustrate a second embodiment of the invention, in which has a hook-to-hook locking mechanism 208. Referring initially to FIG. 9, bending sleeve clamp 20 includes a first rigid sleeve 202 and a second rigid sleeve 204. Rigid sleeves 202 and 204 are permanently connected together by a bending sleeve 216. A flexible tube 206 passes through rigid sleeves 202 and 204 and bending sleeve 216. As shown in the cross-sectional view of FIG. 10, the outside diameter of tube 206 is slightly smaller than the inside diameters of rigid sleeves 202 and 204 and bending sleeve 216.

An arm 210 extends from rigid sleeve 202, and a hook 212 extends from rigid sleeve 204. A second hook 210A is formed at the end of arm 210. Bending sleeve clamp 20 is made of plastic, and arm 210 is shaped (see FIG. 12) so that it flexes slightly, and hook 210A remains engaged with hook 212 when bending sleeve clamp 20 is closed, as shown in FIG. 9. Stops 226 and 228 prevent bending sleeve clamp 20 from moving past the point of closure shown in FIGS. 9 and 10, wherein the axes defined by rigid sleeves 202 and 204 are oriented at an angle of approximately 90 degrees with respect to each other. In this closed position, a kink is formed in bending sleeve 216, closing off the flow of a fluid through flexible tube 206.

As described above, flexible tube 206 is formed of a relatively soft material as compared with bending sleeve 216. Flexible tube 206 may have an outer diameter in the range of 1/16″ to 7/16″, for example.

FIG. 11 shows how bending sleeve clamp 20 may be opened with one hand. The user presses against arm 210 with his or her thumb while supporting sleeve 206 against his or her first finger.

As shown in FIGS. 9 and 12, ridges 202A and 204A are formed on sleeves 202 and 204, respectively. FIG. 12 illustrates how ridges 202A and 204A provide gripping surfaces to assist the user in closing bending sleeve clamp 20 with one hand.

The hook-to-hook clamp 20 shown in FIGS. 9-12 may be used for intravenous tubing, drip irrigation tubing, leveling water tubes and air supply hoses.

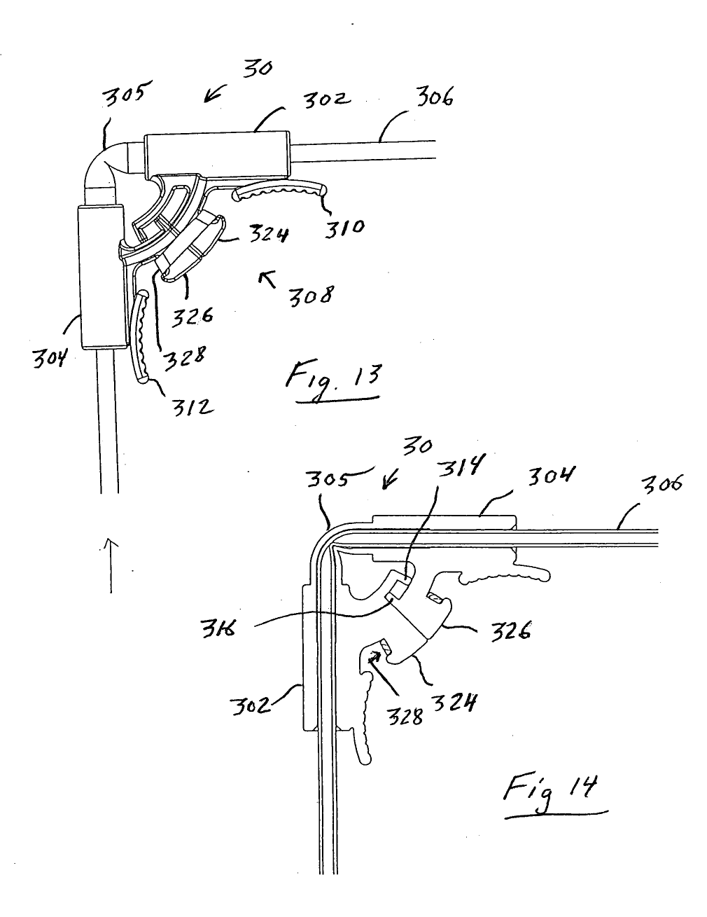

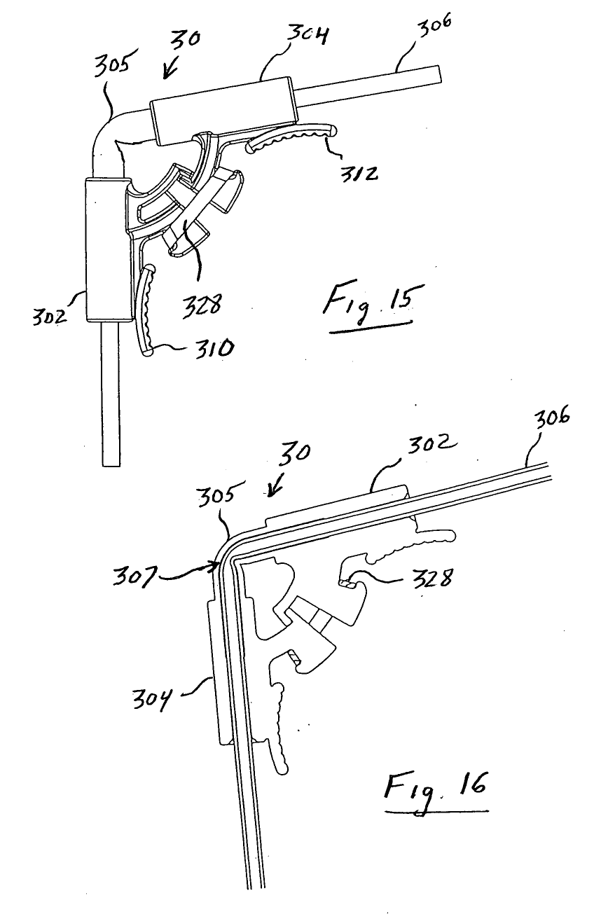

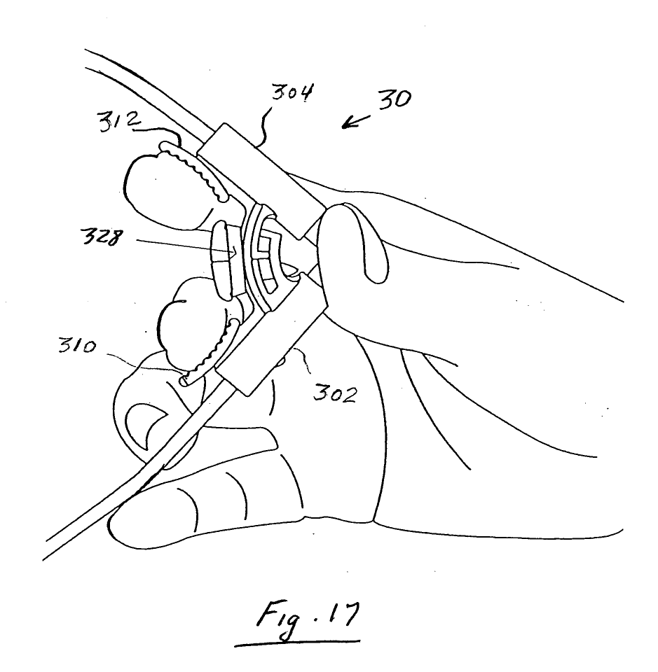

FIGS. 13-17 illustrate a third embodiment of the invention, which utilizes an elastic band to maintain the clamp normally in the closed position. In bending sleeve clamp 30, rigid sleeves 302 and 304 are connected by a bending sleeve 305. A flexible tube 306, which may have an outer diameter of 1/16″ to ¼″, for example, runs through rigid sleeves 302 and 304 and bending sleeve 305. An elastic band 328, preferably made of rubber or silicone rubber, is wrapped around stops 324 and 326, which are part of locking mechanism 308. Each of stops 324 and 326 has a channel for retaining elastic band 328 and a flat surface which abuts against the flat surface of the other stop to hold bending sleeve clamp 30 is the closed position shown in FIGS. 13 and 14, with bending sleeve 305 bent 90 degrees. This structure is clearly shown in FIG. 14.

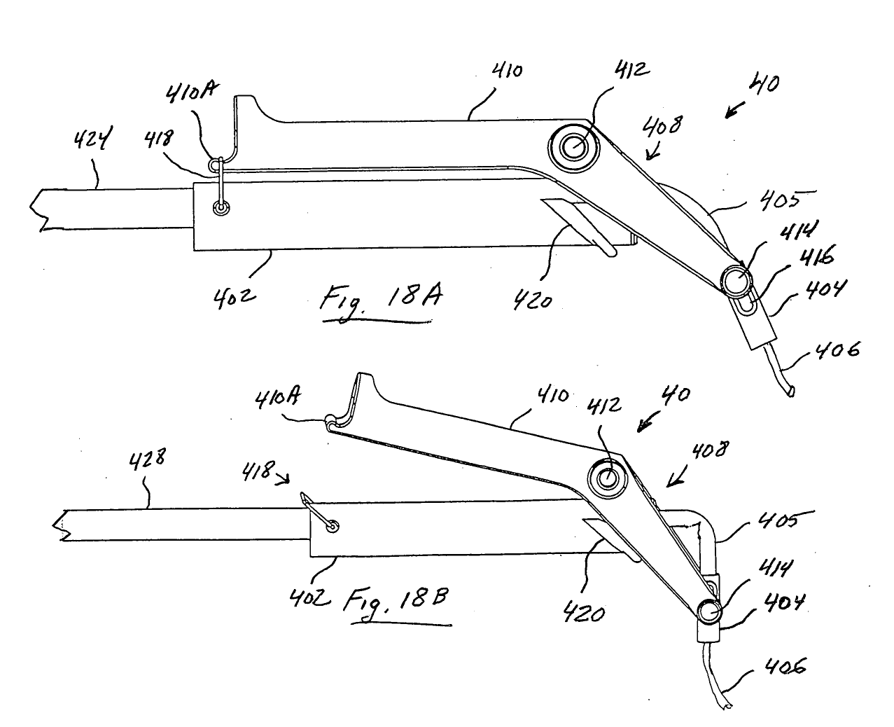

A prong 314 extends from stop 324 and a prong 316 extends from stop 326. As shown in FIGS. 14 and 16, prongs 314 and 316 interact with each other to prevent bending sleeve clamp 30 from being opened by more than a predetermined amount (angle). FIGS. 15 and 16 show bending sleeve clamp 30 in the open position. FIG. 16 shows that in the opening position bending sleeve 305 has relaxed slightly, allowing a small opening 307 to form in flexible tube 306.

Referring again to FIG. 13, rigid sleeves 302 and 304 also contain finger pads 310 and 312, respectively, which are useful for opening bending sleeve clamp 30 with the fingers and thumb of one hand, in the manner shown in FIG. 17, with the thumb pressed against bending sleeve 305 and the first and second finger gripping finger pads 310 and 312.

Bending sleeve clamp 30 is particularly useful for small pressurized air, water, and corrosive liquid tubes.

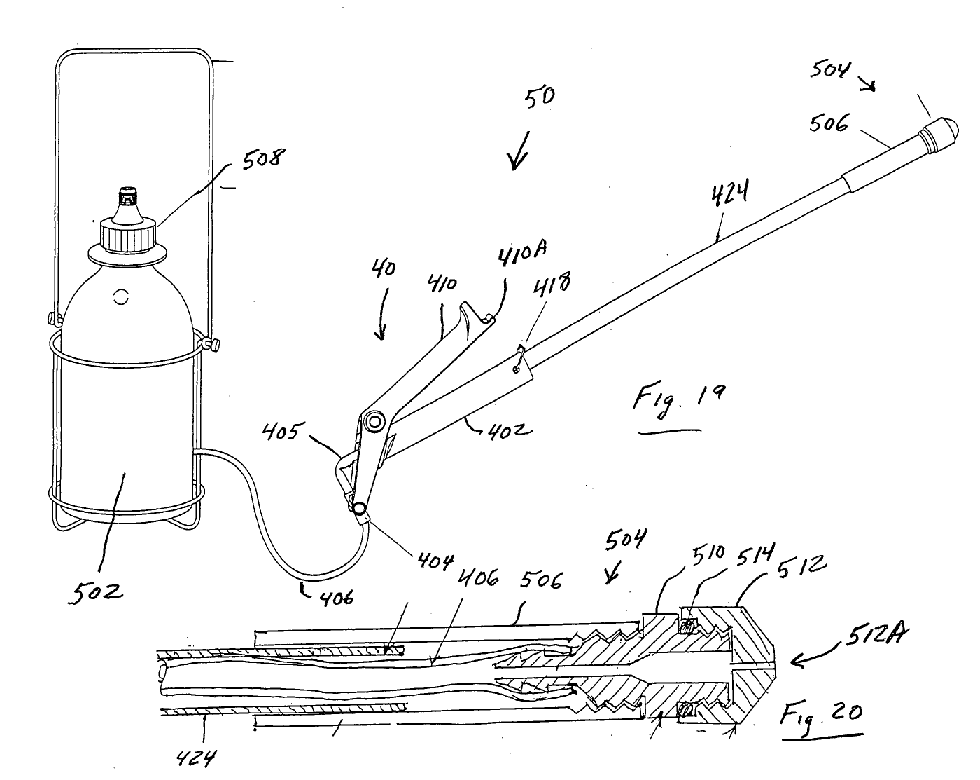

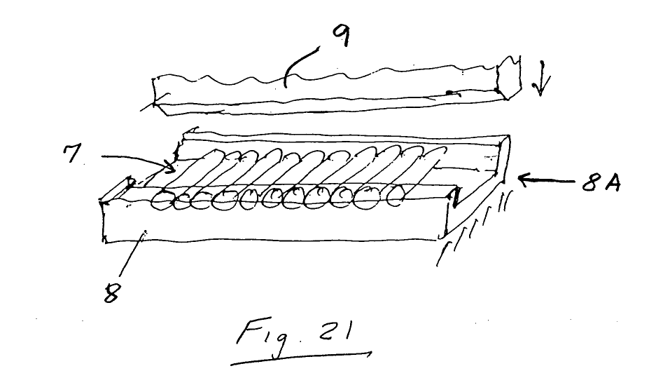

FIGS. 18A and 18B illustrate a fourth embodiment of the invention, a handle-type bending sleeve clamp 40. FIG. 18A shows bending sleeve clamp 40 in the open position; FIG. 18B shows bending sleeve clamp 40 in the closed position.

Bending sleeve clamp 40 includes a first rigid sleeve 402, a second rigid sleeve 404, and a bending sleeve 405. A flexible tube 406 is inserted through rigid sleeves 402 and 404 and bending sleeve 405. An extension tube 424 is attached to rigid sleeve 402, and flexible tube 406 extends through extension tube 424 also.

A handle 410 is rotatably connected to rigid sleeve 402 by a mechanism that includes a shaft 412. A rotary spring (not shown) is wrapped around shaft 412 and biases handle 410 in a clockwise direction (as shown in FIGS. 18A and 18B) so that a bottom edge of handle 410 rests against a stop 420 when bending sleeve clamp 40 is in the closed position, shown in FIG. 18B. Handle 410 is also rotatably connected to rigid sleeve 404 by a mechanism that includes a shaft 414 and a slot 416. Shaft 414 is free to slide in slot 416 to relieve tensile stress on bending sleeve 405 as bending sleeve clamp 40 moves between the open and closed positions.

When bending sleeve clamp 40 is in the closed position, bending sleeve 405 is bent at a 90 degree angle, and a kink in bending sleeve 405 pinches flexible tube 406, closing off flow in flexible tube 406, as described above. Bending sleeve clamp 40 is maintained in the open position, shown in FIG. 18A, via a locking ring 418, which fits over a prong 410A of handle 410. In the open position bending sleeve 405 is relaxed, allowing fluid to flow through flexible tube 406. It should be noted that that the bend in bending sleeve 405 is somewhat less than 180 degrees when bending sleeve clamp 40 is in the open position.

FIG. 19 shows how bending sleeve clamp 40 can be used in a spraying system 50. One end of flexible tube 406 is connected to a fitting (not shown) on the bottom of a pressure tank 502. Flexible tube 406 then runs through bending sleeve clamp 40, as described above, and through extension tube 424 to a nozzle 504. A valve stem cap 508 at the top of pressure tank 502 can be connected to an air chuck to supply pressure tank 502 with compressed air.

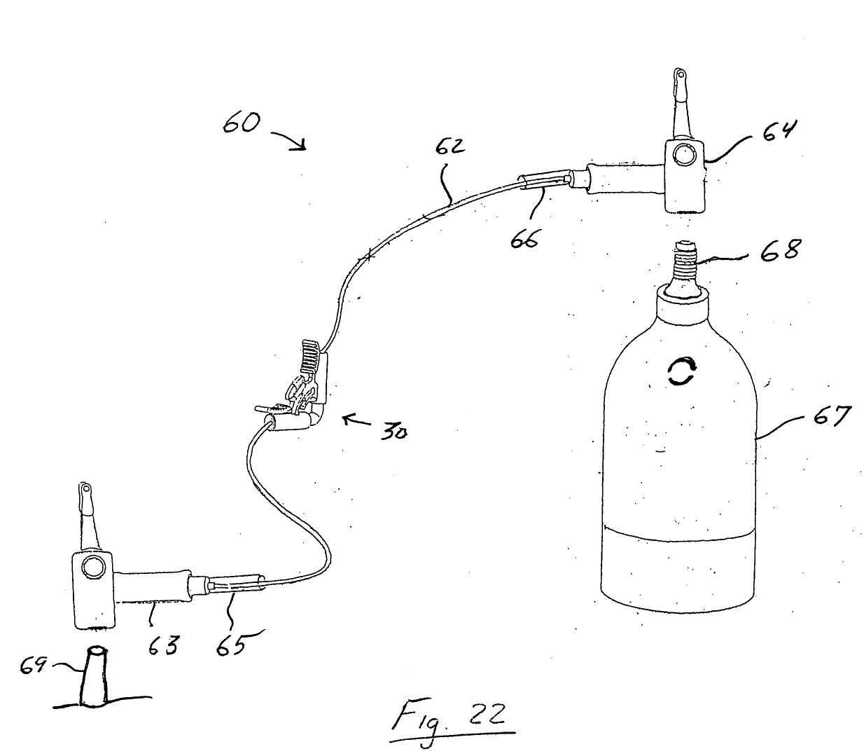

FIG. 20 shows a cross-sectional view of nozzle 504. Extension tube 424 is press-fit into an extension socket 506. A male barbed connector 510 is threaded into one end of extension socket 506, and an end of flexible tube 406 fits over barbed connector 510. A female sprayer head 512 is threaded onto male barbed connector 510, and the joint between female sprayer head 512 and male barbed connector 510 is sealed with an O-ring 514. Thus, when bending sleeve clamp 40 is opened, a fluid may flow from flexible tube 506 through male barbed connector 510 and be ejected through an orifice 512A in female sprayer head 512.

Referring again to FIG. 19, the user may conveniently grasp bending sleeve clamp 40 in one hand and squeeze handle 410 to rigid sleeve 402 in order to open bending sleeve clamp 40. If the user desires to keep bending sleeve clamp in the open position, he or she simply slips locking ring 418 over prong 410A. To close bending sleeve clamp 40, the user simply releases locking ring 418, and the spring which encircles shaft 412 (see FIG. 18A) returns bending sleeve clamp 40 to its closed position.

The bending sleeve clamp of this invention is highly versatile and can be used in numerous applications. One such use is in the inflation system 60, shown in FIG. 22. Inflation system 60 includes a flexible tube 62, which runs through a bending sleeve clamp 30 (shown in FIGS. 13-17); air chucks 63 and 64; anti-kink connectors 65 and 66; and a pressure bottle 67, which is fitted with a valve stem cap 68. In one embodiment, air chucks 63 and 64 are identical. Air chuck 63 connects to valve stem cap 68. Air chuck 64 connects to the article to be inflated, in this case represented by a tire stem 69 (or a stem that is adapted to fill a football, inflatable toy or balloon). Bottle 67 is filled with a pressurized gas, typically air, and after the air chucks 63 and 64 have been connected to valve stem cap 68, bending sleeve clamp is opened in the manner described above to allow the pressurized gas to flow from bottle 67 to the tire or other article to be inflated.

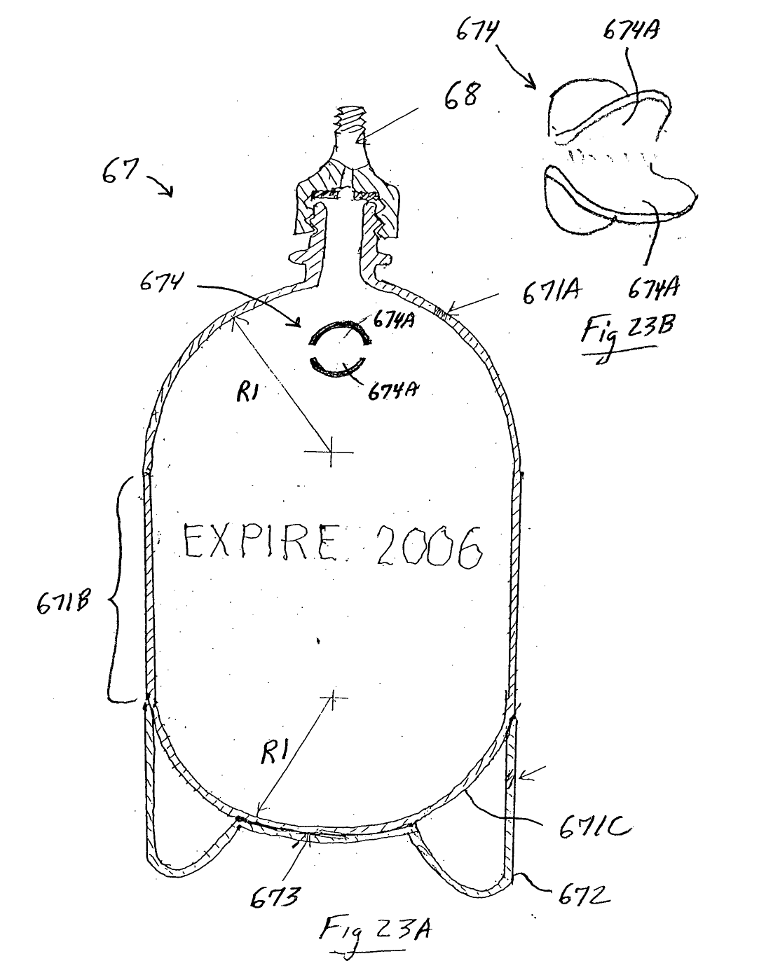

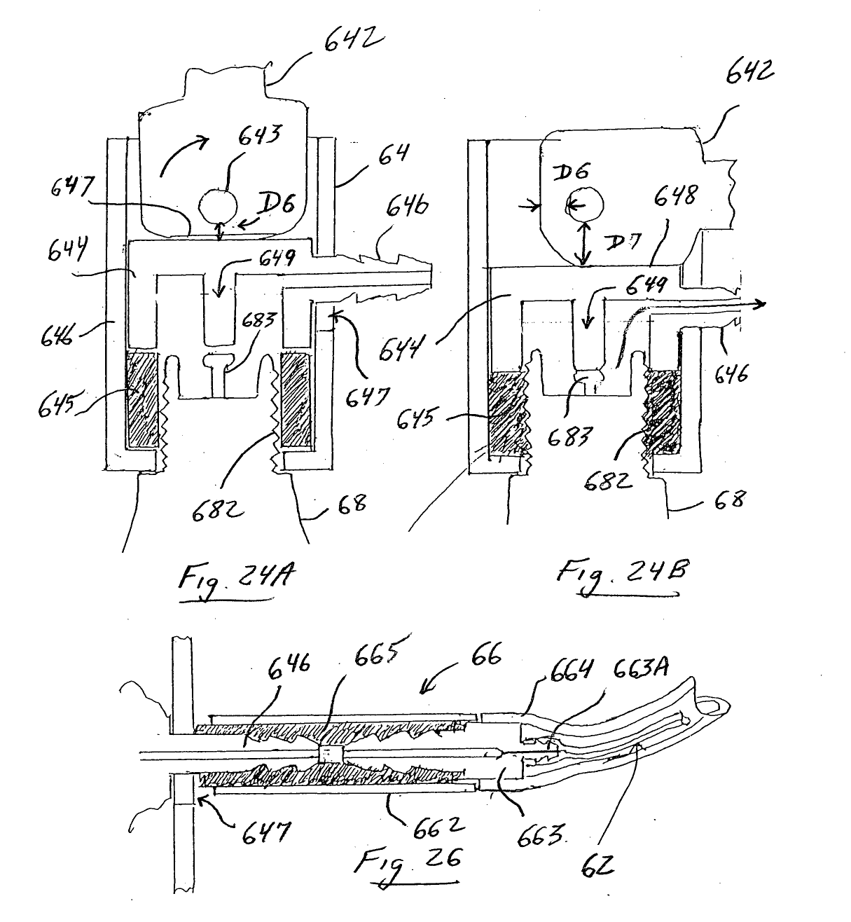

Details of the components of inflation system 60 are shown in FIGS. 23-27.

FIG. 23A illustrates a cross-sectional view of pressure bottle 67. Pressure bottle 67 is preferably made of polyethylene terephtalate (P.E.T.) having an inverted gravity (I.V.) of 84 and is manufactured by an extrusion blow mold process. The walls of bottle 67 can be in the range of 0.5-1.0 mm thick, and bottle 67 may have a volume of 2-4 liters, for example.

Structurally, pressure bottle 67 is divided into three parts: upper and lower portions 671A and 671C, each of which is in the shape of a half-sphere having a radius of R1, and a middle portion 671B, which is in the shape of a cylinder having a radius of R1. A valve stem cap 68 is screwed onto the mouth of pressure bottle 67.

Pressure bottle 67 is supported on a bottom skirt 672, which may be made of polyethylene and may be attached to lower portion 671C by a layer of glue 673.

An indentation 674 is hot-stamped into the wall of pressure bottle 67 to provide protection against bursting. The thickness of wall at indentation 674 is less than the thickness of the other portions of the wall. The thickness of the wall at indentation 674 is designed such that, if bottle 67 is pressurized to a level in excess of the working pressure, the wall of bottle 674 will rupture at indentation 674, releasing the pressure and preventing other portions of the wall from bursting. For example, the thickness of the wall of pressure bottle 67 may be reduced by one-half in indentation 674. In this embodiment, indentation 674 is formed in the shape of two arcs which define opposing flaps 674A. As shown in FIG. 23B, flaps 674A bend outward when indentation 674 is broken as a result of excessive pressure inside pressure bottle. No solid material is propelled from pressure bottle 67 when indentation 674 is ruptured.

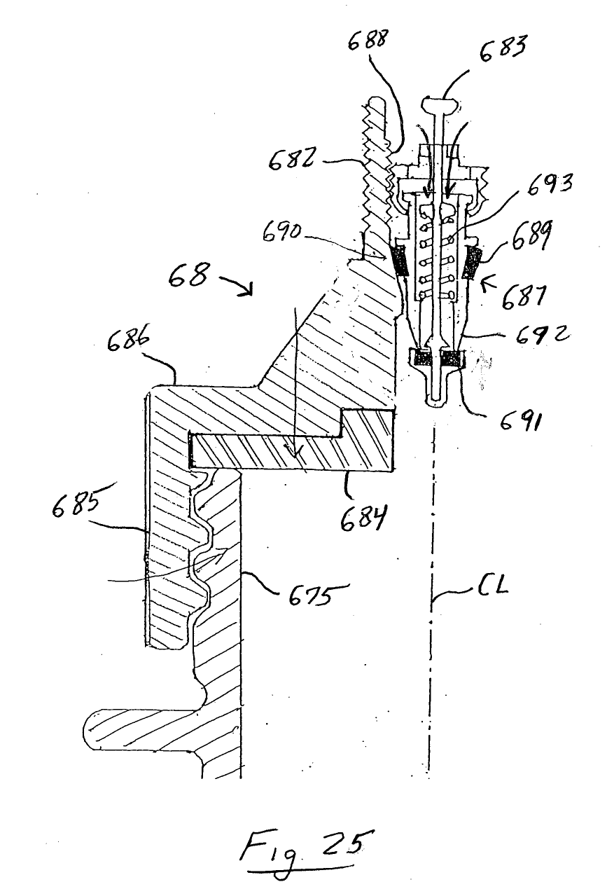

FIGS. 24A and 24B illustrate the connection between air chuck 64 and valve stem cap 68. In FIG. 24A, valve stem cap 68 is closed; in FIG. 24B, valve stem cap 68 is open.

Referring first to FIG. 24A, air chuck 64 fits over a threaded or ribbed portion 682 of valve stem cap 68. Threaded or ribbed portion 682 is in a loose fit with a cylindrical rubber washer 645 that is retained in air chuck 64 by a housing 646. Air chuck 64 contains a lever arm 642 which rotates about a shaft 643. Shaft 643 is separated from a first cam surface 647 of lever arm 642 by a distance D6 and from a second cam surface 648 of lever arm 642 by a distance D7, distance D7 being greater than distance D6. In the open position shown in FIG. 24A, cam surface 648 abuts a plunger 644, which is free to slide in a vertical direction. A male connector 646 which is a part of plunger 644 slides in a slot 647 in housing 646. As a result, as lever arm 642 is rotated 90 degrees clockwise from the position shown in FIG. 24A to the position shown in FIG. 24B, where cam surface 648 abuts plunger 644, plunger is forced downward by a distance equal to D7 minus D6. This action compresses the rubber washer 645, causing rubber washer 645 to grip the threaded or ribbed portion 682 of valve stem cap 68. At the same time, a central protrusion 649 of air chuck 64 forces a head portion 683 of valve stem cap downward. Assuming the pressure bottle 67 is pressurized, this opens valve stem cap 68 (as described below) and allows gas to flow out of pressure bottle 67 and through air chuck 64 via the path indicated by the arrow in FIG. 24B.

FIG. 25 shows a cross-section of a portion of valve stem cap 68 and the mouth of bottle 67. Valve stem cap 68 has a body 686, which can be made of polycarbonate plastic. Valve stem cap 68 is screwed onto the mouth of bottle 67 by means of a threaded portion 685, which has internal threads that mesh with external threads on the threaded portion 675 of bottle 67. A flat rubber washer 684 creates a seal between bottle 67 and valve stem cap 68. Only one-half of body 686 is shown in FIG. 25; the line CL denotes the central axis of pressure bottle 67.

Valve stem cap 68 include a valve stem 687, which is similar to the valve stems commonly used in automobile tires. Valve stem 687 is threaded into an internal threaded portion 688 of body 686. A rubber washer 689 contacts an interior wall of nozzle 690 of body 686 to provide a pressure seal when valve stem 687 is tightened into nozzle 690 of body 686. Normally, head 683 is forced upward by a compression spring 693. This action creates a seal between a washer 691 and a valve seat 692. As head 683 is forced downward by the action of air chuck 64 (as described above), washer 691 is separated from valve seat 692. This allows air to flow through the interior of valve stem 687, as indicated by the arrows.

To summarize, rotating the lever arm 642 of air chuck 64 simultaneously creates a seal between air chuck 64 and valve stem cap 68 and stretches valve stem 687, allowing air (or another gas) to flow through air chuck 64 and anti-kink connector 66.

FIG. 26 is a cross-sectional view of anti-kink connector 66, which provides a connection between flexible tube 62 (FIG. 22) and air chuck 64. Connector 66 includes a sleeve portion 662, made of metal, which is crimped on a rubber socket 665 to connect male connectors 646 and 663, thereby creating a flow path through anti-kink connector 66. Male connector 663 includes a smaller male connector 663A, which is in flow communication with the main passage through male connector 663 and which is sized to accept an end of flexible tube 62. An anti-kink tube 664 fits over an end of sleeve portion 662. To connect flexible tube 62 to connector 66, flexible tube 62 is first passed through anti-kink tube 664 and then pressed onto male connector 663A. Anti-kink tube 664 is then fitted onto sleeve portion 662, completing the connection between flexible tube 62 and air chuck 64.

It will be understood that in this embodiment air chuck 63 and connector 65 are identical to air chuck 64 and connector 66, respectively. Thus, when air chuck 63 is connected to valve stem 69, for example, and air chuck 64 is connected to valve stem cap 68, a continuous flow channel is created between pressure bottle 67 and the automobile tire, blocked only by bending sleeve clamp 30. When bending sleeve clamp 30 is opened (as described above), air flows from bottle 67 to the automobile tire until the desired pressure is reached.

The inflation system of this invention may be used to inflate a wide variety of inflatable articles besides automobile tires, including balloons, balls, air mattresses, floating water toys, and inflatable swimming pools. Various types of adapters, well known in the art, are used to inflate these articles and would be connected between the inflation system and the article to be inflated.

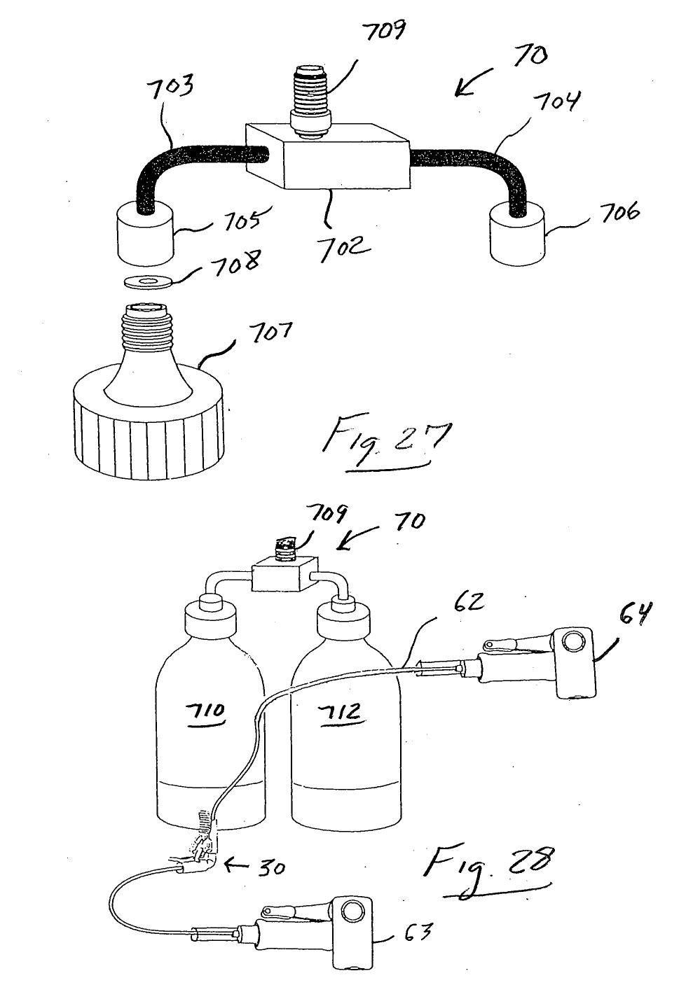

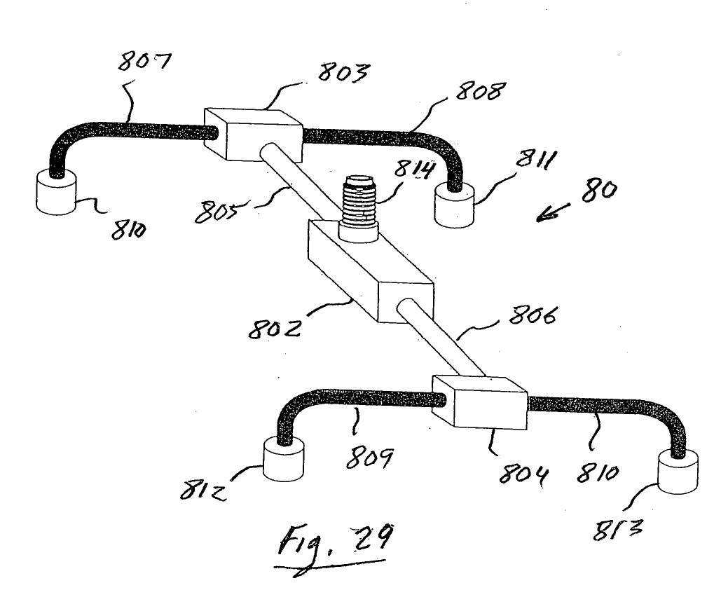

If a greater volume of air is desired, multiple pressure bottles can be joined together. FIG. 27 illustrates an arrangement 70 that can be used to combine the contents of two pressure bottles. Arrangement 70 includes a junction block 702 and tubes 703 and 704, all of which can be made of metal. Fittings 705 and 706 are attached to the ends of tubes 703 and 704, respectively. As shown, fitting 705 is screwed onto a plastic cap of a pressure bottle, with a rubber washer 708 to create a seal. A valve stem cap 709 is connected to junction block 702, in flow communication with tubes 703 and 704. Valve stem cap 709 may be similar to valve stem cap 68. FIG. 28 shows arrangement 70 connected to two pressure bottles 710 and 712. Air chuck 64 would be connected to valve stem cap 709 in the manner described above.

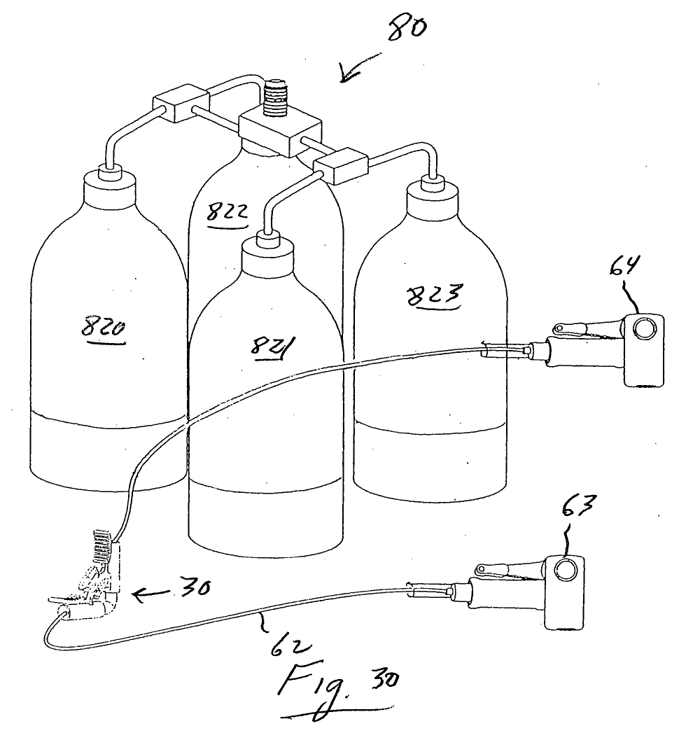

FIG. 29 shows an arrangement 80, which could be used to connect air chuck 64 to four pressure bottles. Arrangement 80 contains three junction blocks 802, 803 and 804, which are linked by tubes 805 and 806. In turn, junction block 803 is connected to fittings 810 and 811 by tubes 807 and 808; and junction block 804 is connected to fittings 812 and 813 by tubes 809 and 810. A valve stem cap 814 is connected to junction block 802 in flow communication with tubes 805 and 806. FIG. 30 shows arrangement 80 can be used to combine the capacities of four pressure bottles 820, 821, 822 and 823.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

We claim:

1. A combination comprising a bending sleeve clamp and a flexible tube, the bending sleeve clamp comprising:
a first rigid sleeve and a second rigid sleeve, said first and second rigid sleeves defining first and second axes, respectively;
a bending sleeve connecting the first and second rigid sleeves, said flexible tube extending through said first and second rigid sleeves and said bending sleeve; and
a locking mechanism capable of orienting said first and second rigid sleeves so as to form a kink in said bending sleeve, thereby creating a closed position of said bending sleeve clamp.

2. The combination of claim 1 wherein said locking mechanism comprises a pair of stops, said stops being positioned so as to define a minimum angle between said axes.

3. The combination of claim 1 wherein said locking mechanism comprises a pair of prongs, said prongs being positioned so as to define a maximum angle between said axes.

4. The combination of claim 1 wherein said bending sleeve is pre-kinked.

5. The combination of claim 1 wherein an angle between said axes is approximately equal to 90 degrees when said bending sleeve clamp is in said closed position.

6. The combination of claim 1 wherein said bending sleeve is made of a material that is harder than the material of which said flexible tube is made.

7. The combination of claim 1 wherein said locking mechanism comprises a buckle mechanism, said buckle mechanism comprising a prong and a slot, said prong positioned so as to fit into said slot and thereby hold said bending sleeve clamp in said closed position.

8. The combination of claim 1 wherein said locking mechanism comprises a pair of hooks.

9. The combination of claim 8 wherein said pair of hooks are engaged, thereby holding said bending sleeve clamp in said closed position.

10. The combination of claim 1 wherein said locking mechanism comprises an elastic band.

11. The combination of claim 10 wherein said locking mechanism comprises a pair of stops, said elastic band enclosing said stops so as to hold said bending sleeve clamp in said closed position.

12. The combination of claim 11 wherein said locking mechanism comprises a pair of prongs, said prongs being positioned so as to define a maximum angle between said axes.

13. The combination of claim 1 comprising a handle rotatably coupled to each of said first and second rigid sleeves, a rotatable connection between said handle and said first rigid sleeve being spring-biased.

14. The combination of claim 13 wherein said first rigid sleeve comprises a stop.

15. The combination of claim 14 wherein said handle abuts said stop when said bending sleeve clamp is in the closed position.

16. The combination of claim 13 wherein a mechanism by which said handle is rotatably coupled to said second rigid sleeve includes a shaft and a slot, said shaft being free to slide in said slot.

17. The combination of claim 16 comprising a locking ring rotatably connected to said first rigid sleeve, said locking ring adapted to fit over a portion of said handle so as to hold said bending sleeve clamp in an open position.

18. A spraying system comprising a bending sleeve clamp, a flexible tube, a tank and a nozzle,
said bending sleeve clamp comprising:
a first rigid sleeve and a second rigid sleeve, said first and second rigid sleeves defining first and second axes, respectively;
a bending sleeve connecting the first and second rigid sleeves, said flexible tube extending through said first and second rigid sleeves and said bending sleeve; and
a locking mechanism capable of orienting said first and second rigid sleeves so as to form a kink in said bending sleeve, said locking mechanism comprising a handle rotatably attached to said first and second rigid sleeves, a rotatable attachment between said handle and said first rigid sleeve being spring-biased, said first rigid sleeve comprising a stop, said handle abutting said stop when said bending sleeve clamp is in the closed position;
a valve stem cap attached to said tank, said flexible tube extending from said valve stem cap through said bending sleeve clamp to said nozzle.

19. An inflation system comprising:
a flexible tube, a first end of said flexible tube being in flow communication with a bottle through a valve stem cap attached to said bottle, said bottle containing pressurized gas, a second end of said flexible tube being in flow communication with an inflatable article; and
a bending sleeve clamp comprising:
a first rigid sleeve and a second rigid sleeve, said first and second rigid sleeves defining first and second axes, respectively;
a bending sleeve connecting the first and second rigid sleeves, said flexible tube extending through said first and second rigid sleeves and said bending sleeve; and
a locking mechanism capable of orienting said first and second rigid sleeves so as to form a kink in said bending sleeve,
wherein said flexible tube passes through said first and second rigid sleeves and said bending sleeve.

20. The inflation system of claim 19 further comprising a first air chuck connecting said flexible tube to said bottle.

21. The inflation system of claim 20 further comprising a second air chuck connecting said flexible tube to said inflatable article.

22. The inflation system of claim 19 wherein said locking mechanism comprises a pair of stops and an elastic band, said elastic band enclosing said stops so as to hold said bending sleeve clamp in a closed position.

23. The inflation system of claim 22 wherein said locking mechanism comprises a pair of prongs, said prongs being positioned so as to define a maximum angle between said axes.

24. The inflation system of claim 19 wherein said inflatable article is an item selected from the group consisting of an automobile tire, a balloon, a ball, an air mattress, a floating water toy, and a swimming pool.

25. The inflation system of claim 19 wherein said bottle comprises a wall, said wall comprising an indentation wherein said wall has a reduced thickness, said reduced thickness being designed to rupture when a pressure inside said bottle reaches a predetermined level.

26. The inflation system of claim 19 wherein said indentation is in the form of a pair or arcs, said arcs being oriented so as to form a pair of flaps when said indentation is broken.
